(19) United States
(12) Patent Application Publication
(10) Pub. No.: US 2020/0143329 A1
(43) Pub. Date: May 7, 2020

(54) SYSTEMS AND METHODS FOR UNBIASED RECRUITMENT

(71) Applicant: Divan Gamaliel, Bayonne, NJ (US)

(72) Inventor: Divan Gamaliel, Bayonne, NJ (US)

(21) Appl. No.: 16/666,939

(22) Filed: Oct. 29, 2019

Related U.S. Application Data
(60) Provisional application No. 62/753,926, filed on Nov. 1, 2018.

(51) Int. Cl. G06Q 10/10; H04N 21/2187; H04N 21/442; G06F 3/16; H04N 5/262; G06K 9/00

(52) U.S. Cl. CPC G06Q 10/1053; H04N 21/2187; H04N 21/44218; G06K 9/00288; H04N 5/262; G06K 9/00302; G06F 3/165

(57) ABSTRACT

Systems and methods are provided for performing unbiased recruitment by modifying one or more informative personal attributes from a resume, or audio or audio-video interviews (live or recorded). Modifying may be masking (e.g., redacting, removing, hiding, covering, etc.) or altering (e.g., blurring, disguising, substituting, replacing, etc.), or both, and may be applied independently to the same or different personal attributes. Personal attributes may be masked, altered, or both, for all or a portion of an interview, with audio and video processing techniques being applied on a concurrent and continuous basis. Personal attributes which may be a basis for bias, discrimination or prejudice, whether conscious or unconscious, during a candidate interview include, without limitation, one or more of: color, gender, age, disability, religion, ethnicity, sexual orientation, appearance, clothes, pregnancy, parental status, marital status, caste, class, address, phone number, accent, salary, college, location, residential address, employment timeline, and the like.

### CROSS-REFERENCE TO RELATED APPLICATIONS

The present application claims the benefit of U.S. Provisional Application No. 62/753,926, filed Nov. 1, 2018, the entire disclosure of which is hereby incorporated by reference herein.

### TECHNICAL FIELD OF THE INVENTION

The present subject matter generally relates to a system and method for performing unbiased recruitment. More particularly, the present subject matter relates to a system and method for masking one or more informative attributes of a candidate and altering one or more personal attributes of text, video and/or audio communications during the recruitment process.

### BACKGROUND OF THE INVENTION

The recruitment process has evolved drastically in last couple of decades owing to advancements in the Information Technology field. Traditionally, a resume was prepared on a paper and delivered to employers or recruiters in person, followed by in person interview, if required and warranted which is at least in part dependent on the candidate's qualifications. The paper resume has been replaced by an electronic resume that might be in written format (e.g., text in MS Word or other word processing application format, printed hardcopy format, one or more typed files as produced during chat session, and combinations of these), video format, audio format, or some combination of these which is electronically deliverable and reviewable. The electronic resume is shared with employers and recruiters through electronic media, such as emails, recruitment websites, social media websites, chat sessions, and the like. If necessary, an interview is arranged, may be in person or through video or audio call, or chat session, etc. Such an interview may be live and interactive, or recorded, or live and also recorded (e.g., for later review).

Though the recruitment process has evolved in procedural aspects, it still has flaws that can result in biased recruitment evaluation and decisions. Foremost flaw of the current process is the potential for prejudiced views and decisions of an employer, recruiter, interviewer, or other decision maker. Usually a resume, whether electronic or not, includes personal information and disclosures. Disclosures of personal information, such as gender, color, ethnicity, culture, religion, sexual orientation, age, and disability, or information (e.g., candidate's first name) from which such personal information could be deduced, might influence the recruiter's or interviewer's view, consciously or unconsciously. Such prejudiced opinions may impinge upon a decision maker's judgment and, therefore, on the recruitment process and result.

One prominent solution to have a fair and unprejudiced recruitment process is to mask (e.g., redact, remove, hide, cover, etc.) the personal information and thereby protect the candidate's identity and attributes from the employer, recruiter, interviewer, or other decision maker throughout the recruitment process. Masking of the data from resume has been attempted in the art previously.

U.S. Pat. No. 7,424,438 discloses a system that collects information, qualifications, and requirements from job seeking candidates and employers. When the system receives a request from a candidate or employer, minimum requirements of the requesting party are disclosed to the non-requesting party. Upon consent, minimum requirements from the non-requesting party are disclosed to the requesting party. To avoid impermissible discrimination, information related to race and gender of the candidate is provided to the employer, if the employer wishes, at the time of or after a hiring decision is made. By not disclosing the personal information earlier, the system contributes to an unbiased recruitment process.

U.S. Pat. No. 6,618,734 discloses that when a candidate accesses a system in response to a published position opening, background information (experience, skills, education, etc.) are collected from the candidate for the system to analyze and determine whether the candidate qualifies for the position opening or not. If the candidate qualifies, interviews are arranged and performed by the system until the suitability of the candidate is determined and then the potential employer is notified of the candidate. Such pre-employment screening and assessment interview process is unbiased because the candidate is judged by the system administering the qualification comparisons and follow up interviews before the potential employer knows anything about the candidate.

Though there have been several contributions in the industry for avoiding discrimination based on personal attributes of the candidates, the solutions have not addressed the problem completely. Hiding personal information at a pre-employment phase may result in unbiased screening process, but discrimination by the potential employer and its representatives has not been avoided at subsequent interview and evaluation phases. It is possible that the final decision of the interviewer may still be influenced by personal attributes. Apart from preconceived notions by the interviewer, there exists another concern in the recruitment process. During remote interviews, such as by phone or video, a candidate may seek help from a friend or access information from other sources (database, Internet, books, etc.) during the video or audio interview, and the interviewer will be deceived. A solution is required to avoid such defrauding interviews as well.

The present invention overcomes the problems and limitations of the prior art, and presents a complete solution to minimize or avoid impermissible discrimination and provide an unbiased and only talent-oriented recruitment process.

### SUMMARY OF THE INVENTION

A method for unbiased recruitment is provided which includes a communication involving one or more users, wherein the communication may be live, interactive, recorded, or a combination thereof, and the user has one or more personal attributes, the method comprising the steps of:

receiving the communication from a first user, wherein the communication comprises: a text file containing words which include at least one personal attribute, an audio file containing audio data which include at least one personal attribute, a video file containing video images which include one or more personal attributes of the first user, or a combination thereof;

masking, altering, or both, one or more of the personal attributes in the communication, prior to providing the communication with another user, by subjecting whichever one or more of the text file, audio file, and video file that are present in the communication to a processing technique to produce a modified text file, a modified audio file, and a modified video file, respectively, which contain masked, altered, or masked and altered, personal attributes;

correlating and combining one or more of the modified text file, the modified audio file, and the modified video file to produce a modified communication which includes the masked, altered, or masked and altered, personal attributes;

whereby, during subsequent receiving and reviewing of the modified communication by a second user, the second user is unable to view or recognize the masked, altered, or masked and altered, personal attributes of the candidate which would otherwise have been recognizable in the communication prior to the masking, altering, or both, of the personal attributes.

The personal attributes comprise one or more attributes selected from: color, gender, age, disability, religion, ethnicity, sexual orientation, appearance, clothes, pregnancy, parental status, marital status, caste, class, address, phone number, accent, salary, college, location, residential address, and employment timeline.

The method for unbiased recruitment may further comprise the step of providing the modified communication to the second user by: allowing receiving and reviewing of the modified communication by the second user continuously during at least a portion of the step of correlating and combining to produce the modified communication, storing the modified communication on storage media for future receiving and reviewing by the second user, or both.

The communication may be recorded, live, interactive, or a combination thereof, and is selected from: a resume, an interview, a job description, an employer description, or a combination thereof.

In some embodiments of the method for unbiased recruitment, when the communication is live, the step of masking, altering, or both, one or more of the personal attributes in the communication and the step of correlating and combining to produce the modified communication which includes the masked, altered, or masked and altered, personal attributes are both performed concurrently and continuously during at least a portion of the step of receiving the communication from the first user.

In some embodiments, the first user is a candidate, the communication is a recorded, live or interactive resume, or a recorded, live or interactive interview, and the second user is an employer or an agent thereof, an interviewer, or a recruiter.

In some embodiments, the first user is an employer or agent thereof, or a recruiter, and the communication comprises: a job description, an employer description, or a combination thereof.

In some embodiments of the method for unbiased recruitment, the user is a candidate having one or more identification attributes unique to the candidate, and a candidate database which is accessible by the manager module contains one or more previously stored identification attributes of the candidate, the method further comprising the step of verifying candidate identity prior to commencing the communication by: acquiring at least one identification attribute from a user wishing to participate in performing the communication; retrieving the one or more previously stored identification attributes from the candidate database; and determining whether any of the acquired identification attributes of the user matches any of the one or more previously stored identification attributes from the database. In such embodiments, if the result of the determining step is a match, reporting verification of the candidate identity and allowing the user to participate in the communication as the candidate, or if the result of the determining step is failure to match any previously stored identification attributes, then reporting failure of verification of the candidate identity to the candidate and any other user intending to communicate with the candidate.

In some embodiments, the method for unbiased recruitment further comprises the step of analyzing the communication to determine one or more emotions expressed by the first user during the communication by: subjecting one or both of an audio file and a video file of the communication to an emotional analysis technique to produce a first emotion data file comprising one or more emotional indicators each of which identifies an emotion expressed by the first user during the communication; and either.

correlating and integrating the first emotion data file with one or more of the text file, audio file, and video file, to produce the modified text file, the modified audio file, and/or the modified video file, respectively, such that the step of correlating and combining one or more of the modified text file, the modified audio file, and the modified video file produces a modified communication which further comprises the one or more emotional indicators; or

compiling and producing a report from the first emotion data file which is separate from the modified communication and contains the one or more emotional indicators, with or without time readings to indicate at which part of the communication the first user expressed or manifested the emotion.

In some embodiments, a second user also participates in the communication and the method for unbiased recruitment further comprises the step of analyzing the communication to determine one or more emotions expressed by the second user during the communication by: subjecting one or both of the audio file and the video file of the communication to an emotional analysis technique to produce a second emotion data file, which may be combined with the first emotion data file to produce a combined emotion data file which further comprises one or more emotional indicators each of which identifies an emotion expressed by the second user during the communication, or is a separate second emotion data file which comprises one or more emotional indicators each of which identifies an emotion expressed by the second user during the communication; and either

correlating and integrating the second emotion data file or the combined emotion data file with one or more of the text file, audio file, and video file, to produce the modified text file, the modified audio file, and/or the modified video file, respectively, such that the step of correlating and combining one or more of the modified text file, the modified audio file, and the modified video file produces a modified communication which further comprises the one or more emotional indicators; or

compiling and producing a report from the second emotion data file which is separate from the modified communication and contains the one or more emotional indicators each of which identifies an emotion expressed by the second user during the communication, with or without time readings to indicate at which part of the communication the second user expressed or manifested the emotion.

In some embodiments, the method for unbiased recruitment further comprises the steps of: subjecting the text file, the audio file, or both to a personality analysis technique to determine one or more personality traits possessed by the first user; and producing a personality report containing the one or more personality traits, a personality description, a personality profile, or a combination thereof.

A system for performing unbiased recruitment of a candidate for job openings is also provided which comprises:

an application server comprising at least an audio-visual processing unit and a data processing unit;

a job database server in communication with the application server and having stored thereon one or more job openings and one or more required talent attributes associated with each job opening;

a candidate database server in communication with the application server and having stored thereon one or more identification attributes associated with the candidate, one or more personal attributes associated with the candidate, and one or more talent attributes associated with the candidate, wherein the attributes are written words, audio signals, video images, or a combination thereof;

at least one user interface unit in communication with the application server and comprising one or more capture or display devices and being capable of enabling users selected from the candidate, an interviewer, and a recruitment manager, to communicate with the application server and each other to perform the unbiased recruitment; and

optionally, a physical location unit comprising one or more restricted access physical locations, each of which includes a user interface device, and wherein the candidate is prohibited from bringing any personal electronic devices into any of the physical locations.

In some embodiments, the audio-visual processing unit comprises one or more of: a verification component capable of verifying identification of the candidate, an audio alteration unit capable of receiving one or more audio signals from the candidate through one or more capture devices of the user interface unit, altering the received audio signals, and providing the altered audio signals to the interviewer through the one or more display devices of the user interface unit; and a video alteration unit capable of receiving one or more video images from the candidate through one or more capture devices of the user interface unit, altering received video images, and providing the altered video images to the interviewer through the one or more display devices.

In some embodiments, the application server further comprises a facial recognition unit capable of receiving facial feature data from the one or more capture devices of the user interface unit, analyzing the facial feature data, verifying identification of the candidate prior to an interview, and determining emotions of the candidate during an interview which may be otherwise undetectable by the interviewer due to altering or masking of the video images.

### BRIEF DESCRIPTION OF THE DRAWINGS

The present invention will be further explained with reference to the attached drawings, in which:

FIG. 1 is a schematic chart showing various components and units which comprise an exemplary embodiment of a system for unbiased recruiting in accordance with the description provided herein.

### DETAILED DESCRIPTION

The present invention provides a system and method for performing unbiased recruitment by modifying one or more informative personal attributes from a resume, or audio or audio-video interviews or recordings, or other communications between candidates, employers, interviewers and recruiters. Modifying one or more personal attributes is performed to prevent disclosure of selected personal attributes and include masking (e.g., redacting, removing, hiding, covering, etc.) or altering (e.g., blurring, disguising, substituting, replacing, etc.), or both. Personal attributes may be a basis for bias, discrimination or other unjust or even unlawful prejudicial judgment, whether conscious or unconscious, during a candidate interview or other communication in similar contexts. Such personal attributes include, without limitation, one or more of: color, gender, age, disability, religion, ethnicity, sexual orientation, appearance, clothes, pregnancy, parental status, marital status, caste, class, address, phone number, accent, salary, college, location, residential address, employment timeline, and the like.

More particularly, the present invention applies to recruitment methods in which, for example, a resume (written, text or word file(s), recorded audio-video format, recorded audio format, etc.) of a prospective candidate is provided to, or otherwise shared with, a prospective employer or recruiter. The resume typically includes talent oriented information (i.e., talent attributes) and personal information (personal attributes) of the candidate. The talent attributes of a candidate typically include, for example without limitation, work experience, education level and subject, skills, training, certifications, awards, publications, expectations, professional achievements, and the like.

Although the method and system of the present invention are discussed hereinafter as involving and being applied to resumes and interviews, it should be understood that the method and system described herein are easily and readily applicable to many types of communications, including without limitation, resumes, interviews, job descriptions, employer descriptions, and the like. Additionally, it should also be clear and understood that, although the method and system of the present invention are described herein as being used or performed by candidates, employers, recruiters, and other decision makers, several kinds of users, including without limitation, candidates, interviewers, recruiters, employers and agents thereof, interview coaches, human resources professionals, recruiting managers, decision makers, and others, will find the method and system useful and beneficial for performing and participating in unbiased recruiting.

More particularly, for example, when sharing a resume, the talent oriented information is shared and at least a portion of the personal information is masked or altered. The candidate may then be called in for, or remotely subjected to, an interview, if his/her talent oriented information is found suitable for a job opening. The interview may be arranged and conducted through any of several methods, formats and media, as known now or in the future to persons of ordinary skill in the relevant art, such as without limitation, an audio call, an audio-video call, a chat session, and optionally in an electronic or live setting, either live, recorded, or interactive and recorded (i.e., such as through an automated internet interface, through an audio-video call which is live and also recorded, or even a chat session which is recorded as a text or other word memo or file, etc.). A candidate may be interviewed by any one of several possible decision makers, such as, without limitation, a prospective employer, an interviewer as an agent of an employer, a recruiter, or even an automated system or application (i.e., through an application, internet module, online intake form, or website page(s), etc.). Identity of the candidate to be interviewed is typically verified before starting the interview.

In some embodiments of the method described herein, other users such as an employer or recruiter may provide a communication, such as a job description for a position to be filled which includes one or more talent attributes desired and/or required for a candidate to have in order to be qualified for the position. Additionally, in such embodiments, the method may include a matching phase prior to any interview and which comprises the steps of reviewing and comparing the talent attributes of a candidate (e.g., provided in a resume type of communication) and the talent attributes of a job description, followed by reporting whether and to what degree the talent attributes of the candidate and job description match. Depending on the degree of matching (e.g., all or a portion of required attributes, and/or all of some of the desired attributes), either or both of the candidate and employer are notified to determine whether an interview or other communication is warranted or desired.

Typically, but not necessarily, and depending in part on the format, a communication such as an interview with a candidate will comprise at least an audio file which includes a plurality of audio data and may comprise a video file which includes a plurality of video images (e.g., video frames), and may also comprise a text file which includes a transcription of at least a portion of the audio data. The plurality of audio data and the plurality of plurality of video images contain one or more personal attributes of the candidate. During the interview (or optionally after the interview, but before providing to a decision maker, such as if the interview is recorded), video and audio processing techniques are used to modify video images and/or audio data to mask or alter (or both) one or more personal attributes in the audio data and video images, in order to protect (i.e., avoid disclosure of) one or more personal attributes of the candidate. Suitable video and audio processing techniques are not particularly limited and may be any such techniques known now or in the future to persons of ordinary skill in the relevant art. For example, such techniques include, without limitation, Text to Speech conversion, Speech to Text conversion, Speech synthesis, Video Manipulation.

In some embodiments, all of the personal attributes in the audio data of an audio file may be masked or altered (or both) to produce a modified audio file. In some embodiments, all of the personal attributes of the video images of a video file may be masked or altered (or both) to produce a modified video file. In some embodiments, a portion of the personal attributes in the audio signal of an audio file may be masked and a different portion of the personal attributes in the audio data of the audio file may be altered to produce a modified audio file. In some embodiments, a portion of the personal attributes in the video images of a video file may be masked and a different portion of the personal attributes in the video images of the video file may be altered to produce a modified video file. In some embodiments, a portion of the personal attributes in the audio data of an audio file of an interview may be masked or altered (or both) to produce a modified audio file, and a portion of the personal attributes in the video images of a video file of the same interview may be masked or altered (or both) to produce a modified video file which correlates to the modified audio file. In some embodiments, at least a portion of the audio data of an audio file may be masked or altered (or both) during only a portion of an interview, such that at least some of the personal attributes of the candidate are revealed to the decision maker prior to the end of the interview.

In some embodiments, audio data of an audio file from an interview that have been modified (i.e., at least a portion of the personal attributes therein have been masked, altered, or both) may be correlated and combined to produce a modified audio file. In some embodiments, video images of a video file from an interview that have been modified (i.e., at least a portion of the personal attributes therein have been masked, altered, or both) may be correlated and combined to produce a modified video file. Where an interview was an audio interview, the modified audio file may, itself, constitute the modified interview which maintains one or more personal attributes of the candidate undisclosed to the decision maker for a portion or all of the modified interview. Where an interview was an audio-video interview, the modified audio file and modified video file are typically correlated and combined to produce modified interview which maintains one or more personal attributes of the candidate undisclosed to the decision maker for a portion or all of the interview. In some embodiments, one or more of the personal attributes may be undisclosed for a portion or all of the interview, while a different one or more personal attributes may be disclosed to the decision maker at different points during the interview.

In some embodiments, the audio and video processing techniques and the correlating and combining of modified audio data and modified video images may produce more than one modified audio file and more than one video file, respectively. This may, for example without limitation, depend upon the particular types of audio and video processing that are performed on the audio files and on the video files. Where more than one modified audio file is produced, these may be further combined into a single final modified audio file. Similarly, where more than one modified video file is produced, these may be further combined into a single final modified video file. Finally, one or more modified audio files may be synthesized and combined with one or more modified video files to produce a modified audio-video interview for providing to or sharing with an employer, an interviewer or other decision maker. Accordingly, it is possible to produce and provide a wide variety of audio interviews and audio-video interviews having different degrees, combinations, and variations of personal attributes which have been masked, altered, or both. It is noted that the processing techniques, correlating and combining may occur in real time, i.e., continuously and concurrently, with a live interview (whether audio or audio-video), or may be performed after an interview is recorded (whether audio or audio-video) and further may be conducted through an automated system or a person, wherein the resulting modified interview would simply be recorded and provided to or shared with the decision maker.

Some or all of the personal attributes of a candidate may be masked, altered, or both, during some or all of an interview. Thus, all of a candidate's personal attributes may remain undisclosed to a decision maker for a portion of the interview, or for the entire interview. Alternatively, in some embodiments, only selected personal attributes of a candidate remain undisclosed to a decision maker for a portion of the interview, or for the entire interview. In some embodiments, at least a portion of the video images of a video file may be masked or altered (or both) during only a portion of an interview, such that at least some of the personal attributes of the candidate are revealed to the decision maker prior to the end of the interview. In some embodiments, all of the audio data of an audio file, or all of the video images of a video file, or all of both, are modified until after the end of the interview, such that no personal attributes are revealed to the decision maker until after the end of the interview.

As will be recognized by persons of ordinary skill in the relevant art, many variations on the foregoing parameters are possible and all such variations are intended to be within the scope of the present disclosure. For example, in some embodiments, an employer or recruiter may elect to perform an interview under “complete blind: or “blind complete” parameters, where at least a portion of a candidate's personal attributes are and remain undisclosed (whether by masking, altering, or both) during the entire interview process, which may involve more than one interview session, with disclosure of the personal attributes only after selection of a particular candidate is made by the employer or recruiter. In other embodiments, an employer or recruiter may elect to perform an interview under “blind lite” parameters, wherein at least a portion of a candidate's personal attributes are and remain undisclosed (whether by masking, altering, or both) during only a portion of an interview, such as after 45 minutes of an interview scheduled for 60 minutes or some other predetermined point during the interview, at which time the undisclosed personal attributes are disclosed and the interview continues until the end of the allotted 60 minutes, or until otherwise completed. In some embodiments, another version of “blind lite” parameters could be where at least a portion of a candidate's personal attributes are and remain undisclosed (whether by masking, altering, or both) during an initial matching phase, and are disclosed (e.g., to an employer or recruiter) if and after the candidate's talent attributes are sufficiently matched with the talent attributes required by a job description. Furthermore, in some embodiments, the candidate may elect to disclose all or a portion of the undisclosed (whether by masking, altering, or both) personal attributes at any point during an interview or other communication. It should be noted that it is contemplated that any of the foregoing and other possible variations may also be applied to mask, alter, or both, one or more of the personal attributes of the other user (e.g., a decision maker such as a recruiter, an employer or agent thereof, an interviewer, etc.) until after an initial matching phase, or during a portion or all of the communication.

In still other embodiments, an employer or recruiter may elect to perform an interview under alternative “blind lite” parameters, wherein at least a portion of a candidate's personal attributes are and remain undisclosed (whether by masking, altering, or both) during only a portion of the interview process, such as from prior to commencement of a first interview to the end of the first interview, at which time only 2 or 3 candidates are selected by the employer or recruiter to participate in a second phase of interviews and at least a portion of the undisclosed personal attributes are disclosed prior to commencement of the second interviews of each selected candidate. It is possible that an employer or recruiter may wish to conduct a second interview with a particular candidate, or for a first interview in connection with a particular open position, with all personal attributes disclosed (i.e., without any masking or altering) right from the beginning, while other aspects of the present method for unbiased recruiting are performed, such as performing the interview remotely, with or without emotional analysis and reporting, or personality analysis and reporting, etc.

In some embodiments, during the interview or other communication (or optionally after the interview or other communication, but before providing to a second user, such as a recruiter, an employer, or other decision maker, such as if the interview or other communication is recorded), audio data, video images, or both, obtained from the interview, may be subjected to an emotional analysis technique known now or in the future, such as emotion recognition analysis, or emotion detection analysis, to produce one or more emotion data files, each containing one or more emotional indicators (or emotional labels) expressed or manifested by one or more users participating in the communication. The emotions identified by the emotional indicators include, for example without limitation: anger, disgust, fear, neutral, sadness, happy, curious, interested, confident, surprised, confused, defensive, concerned, engaged, enthusiastic, combinations thereof, and any others desired to be analyzed and identified. Such emotion data files may or may not be combined or integrated with one or more of the audio files, video files, or both to be part of the modified interview which is provided to or shared with a decision maker. In some embodiments in which the emotion file is combined or integrated into the modified interview, the emotional indicators may be provided as text, or as emoticons, emojis, or other graphic symbols, in one or more of the video images of the interview. In some embodiments, the emotional indicators of the emotion data files may be provided to the decision maker separately (e.g., as a separate report with text or graphic symbols, with or without time readings to indicate at which part of the interview the candidate expressed or manifested the emotions) from the modified audio file, or the modified audio-video file, of the interview from which all files have been derived.

In some embodiments, the audio data, video images, or both, obtained from an interview are subjected to an emotional analysis technique to produce at least one emotion data file containing one or more emotional indicators (or emotional labels) expressed or manifested by a candidate during the communication. In some embodiments, the audio data, video images, or both, obtained from an interview, are subjected to an emotional analysis technique to produce at least one emotion data file containing one or more emotional indicators (or emotional labels) expressed or manifested by a second user, such as a recruiter, an employer or agent thereof, an interviewer, or other decision maker, during the communication. In some embodiments, the audio data, video images, or both, obtained from a communication are subjected to an emotional analysis technique to produce at least one emotion data file containing one or more emotional indicators (or emotional labels) expressed or manifested by two or more users such as a candidate, a recruiter, an employer or agent thereof, an interviewer, or other decision maker, during the communication.

In one example, the candidate's image on one or more video images is altered (e.g., blurred, modified, or even replaced such as with an emoji, avatar, etc.) so that the interviewer cannot identify color, race, ethnicity, age, physical disability if any, or such other apparent characteristic. Furthermore, during an audio-video interview (such as a video interview), the audio data may be altered to protect gender identity, as well as minimizing regional or ethnic accents and voice inflections. Hiding personal attributes of the candidate throughout the recruitment process can avoid conscious or unconscious discrimination until the decision-making point. According to one aspect of the invention, the interviewers can still see facial expressions exhibited by the candidate regardless of masked images. According to another aspect of the invention, the interviewer cannot see facial expressions, however, a facial recognition or analyzer component or personality analysis unit may be applied during the interview to provide the interviewer with information regarding emotions or expressions exhibited during the interview, as well as voice inflections and tone expressed by the candidate, without allowing the interviewer to directly witness such behavior and attributes by the candidate which might otherwise be prejudicing. It is noted that with the process and technology described herein, interviewers may still see and discern facial expressions exhibited by the candidate and also provide personality assessment based on words used by the candidate to talk and type.

In accordance with the methods disclosed and contemplated herein, methods for unbiased recruitment may also comprise acquiring, analyzing and/or recording biometric information of a candidate during all or a portion of audio or audio-video interviews. For example, data may be obtained using techniques, known now or in the future to persons of ordinary skill in the relevant art, including but not limited to retinal scanning, facial analysis, finger print analysis, voice scanning, and combinations thereof. The biometric information acquired by such devices and techniques includes, for example without limitation, retinal patterns, facial features, facial dimensions, finger prints, and voice patterns. Such biometric information and techniques relating to same may be useful as part of the methods for unbiased recruitment, for example, to verify identity of candidates being interviewed, or to provide data for emotional or personality analysis and reporting, whether separate from, in addition to, or in combination with, audio data and video images and analysis thereof as described above.

In accordance with the methods disclosed and contemplated herein, the method may include performing and providing decision makers with a personality assessment of a candidate by subjecting the text file, audio file, or both, of a resume or interview, which may be in text, audio, or audio-visual format (any of which may be live or recorded), to a word analysis technique capable of analyzing the words in such files and determining and reporting personality traits based on those words used by the candidate. The word analysis technique is not limited and may be any such technique known now or in the future to persons of ordinary skill in the relevant art. One such word analysis technique is Linguistic Inquiry and Word Count (LIWC) technology and may be used, for example, to analyze the candidate's words in a resume, or other pre-interview communication, and then determine and report the candidate's personality traits. When determined prior to an interview, the candidate's personality traits may be used to match and evaluate a candidate's suitability for a job description which includes preferred or required personality traits. One or more such personality traits include, for example without limitation: thinking style, persuasive, work bias, openness, emotionally aware, conscientiousness, disciplined, ambitious, dutiful, organized, extraverted, sociable, friendly, confident, assertive, energetic, cheerful, agreeableness, trusting, cooperative, empathetic, genuine, humble, neuroticism, impulsive, anxious, aggressive, self-conscious, social skills, insecure, cold, happiness, working style insights, independent, power driven, Type A, Type B, workhorse, interests and other orientations, combinations thereof, and any others desired to be analyzed and identified. Such a personality trait assessment could also be performed on the candidate or a recruiter, employer, interviewer, or other decision maker, during or after an interview and the results provided to the other user to assist in determining whether there is a good match or if any concerns exist for either user based on the other's personality traits. Alternatively, or additionally, a personality assessment may produce a personality report containing least one or more personality traits, a personality description, a personality profile, or a combination thereof. Such personality reports are typically, but not necessarily, provided to or shared with a decision maker as a written report separately from any audio or video files, audio interview or audio-video interview and after the interview is complete.

Also in accordance with the methods disclosed and contemplated herein, where an initial matching phase is performed to determine suitability of a candidate and his or her talent attributes for a job description, the method for unbiased recruitment may further comprise the step of searching nearby matched candidates with one or more of a matched recruiters, matched employer or agent thereof, matched interviewer, or a combination thereof. Such a searching step may, for example without limitation, be performed using a smartphone camera coupled with an augmented reality processor or application to alert one or both users (e.g., a candidate and a decision maker) to a possible match and offer the choice and opportunity to communicate further.

In still other embodiments, the method of unbiased recruitment may further comprise determining and reporting the degree of rapport, during an interview, between a candidate and one or more other users (e.g., an employer, a recruiter, an interviewer, etc.), by subjecting audio data, text data (transcribed from audio files or otherwise provided and captured), or both, obtained from the interview, to one or more word analysis techniques known now or in the future, such as LIWC, Language Style Matching (LSM), or combinations thereof, for personality analysis and assessment. Such word analysis techniques may, in addition to, or instead of, producing personality assessment reports, be capable of calculating or otherwise determining a degree of rapport, or a rapport score (such as, for example without limitation, on a scale of from 0 (e.g., no rapport) to 100 (e.g., full or complete rapport)) between the users. Determining and reporting the degree of rapport or rapport score to one or more users may be performed, for example, intermittently or continuously during an interview (whether live or recorded), or after an interview, or a combination thereof such as determining rapport during an interview and reporting the rapport after the interview.

Another feature or component which may, optionally, be included in the methods for unbiased recruiting is live (i.e., concurrent, continuous) transcription, translation or other language analysis processing which cooperates with, or operate in addition to, the above-described audio processing techniques. From the audio file created during the interview, such live language analysis processing could produce and provide continuous text to the video output received by one or both users during all or a portion of the interview, for example without limitation, closed captioning for hearing impaired users or for environments and locations which limit or prohibit audio output, when there is background noise interference at one or both user locations, or to provide language translations when the users do not easily or fluently speak the same language.

It should be noted that algorithms, software modules, software and/or internet applications suitable for performing the various different possible processing, analyzing, correlating, and combining techniques described above for analyzing, manipulating and modifying audio, video, and word or text data and files, may be obtained from any of various sources, including custom developed, separately developed and commercially available from separate sources as separate components which can be purchased or licensed and applied to and combined with the methods described herein to perform the methods for unbiased recruiting described herein.

As described above, the integrity of the recruitment process is of greater concern when interviews are conducted remotely due to the relative ease and temptation for candidates to consult other resources (another person, internet, books, etc.) or even to substitute another person for themselves, during a portion or all of an interview to improve their apparent performance. Accordingly, in some embodiments, the present methods and systems further include steps or components (e.g., a manager module) for verifying the identity of the candidate before and during an interview using information provided and captured as described above, including voice and video image matching techniques, or matching biometric characteristics. In the event it is determined, at any time during the interview, that the candidate's identity verification fails or cannot be confirmed, the interview is automatically terminated. This is one of several possible process breaches which constitutes cause for termination of an interview.

Another possible breach which may warrant termination of an interview might be if one or more personal attributes which were intended to be undisclosed is inadvertently disclosed by or to one or more users, such as if a candidate were to verbally disclose their gender, race or ethnicity, if an interviewer were to ask or guess a candidate's gender, race or ethnicity. To recognize such breaches and terminate an interview when they occur, the audio processing technique may include an analysis and concurrent, ongoing matching of the words spoken or typed by both users during the interview against a list of personal attributes selected to remain undisclosed until a predetermined point in the interview process. It is within the ability of persons of ordinary skill to determine and develop many such alternative checks and termination parameters and procedures, as preferred by the users.

For example, as will be understood by persons of ordinary skill in the relevant art, there are several possible scenarios and procedures which are suitable for addressing possible breaches of the recruitment process for failure of identity verification, for example as follows, when the method includes capture and analysis of biometric information:

Identity Verification Failure at Start of Interview/Session:
first attempt: User warned and second attempt given
second attempt: User warned and third attempt given
last attempt: Meeting put on hold and person requested to call customer support. Account put on hold. Other party received notification of issue.

Identity Verification Failure During Interview/Session:
after second failure: interview/session is put on hold while parties are contacted to seek correction or resolution, or
after third failure: interview/session is cancelled. Account put on hold. Notification of the failure is sent to other party/user.

Identity Verification Failure At Physical Login Device/Location:
first attempt: User warned and second attempt given
second attempt: User warned and third attempt given
last attempt: login failed and account put on hold. Notification of the failure is sent to other party/user, if applicable.

Furthermore, it is contemplated that any of the audio, video, text, biometric or other information and data described above as being about or from a candidate and which is provided by and captured from a resume or during an interview may, also or alternatively, be about or from a decision maker, such as an interviewer or recruiter, and provided by and captured during an interview, or other presentation, such as an open position description, or company profile. Such information and data, when analyzed as described above to produce modified files with undisclosed personal attributes (e.g., gender, accent, race, ethnicity) and/or reports with emotional indicators, personality analysis, rapport score, etc., may be helpful to minimize or eliminate bias on the part of candidates, as well as providing candidates with useful information for their consideration during deliberations concerning the open position and prospective employer. Thus, although intuitively applicable to candidate evaluation, the methods and systems for unbiased recruitment described and contemplated herein are also applicable to employers, interviewers, recruiters, etc., and, therefore, it should be clear that potential beneficiaries of these methods and systems include any of the following users: candidates, interviewers, recruiters, employers or agents thereof, interview coaches, human resources professionals, recruiting managers, and others.

The methods for unbiased recruitment may further comprise a reporting component which collects and records statistics and other information concerning the interview and participating users and provides a summary report which may, without limitation, include one or more of the following items: duration of the interview/session, user statistics (e.g., when each of the candidate and interviewer joined the interview, time spent speaking by each, number of questions posed by each, average length in time or words of answer to questions, list of important/key words used by each, etc.), facial emotion statistics, voice emotion statistics, LSM/rapport score, hyperlink to transcripts, hyperlink to audio or audio-visual recording, and any other information which may be considered useful to the users, manager or developers of the methods and systems for unbiased recruiting described herein.

Systems for implementing the methods for unbiased recruitment will now be described, with various exemplary and non-limiting embodiments included. The terms ‘component’, ‘unit’, and ‘system’ as used herein are intended to refer to a computer related entity, either hardware or software or process or combination of process, hardware and software. Entities referred by these terms can be localized on one electronic device, such as computer, device, phone, and tablet, and/or distributed between two or more electronic device. Further, the term ‘database’ is intended to refer to one or more computer related entities for the storage and the access of data. The term ‘database’ is not limited to any manner or structure in which the data is stored.

In some embodiments, the system may be a networked client-server communication system. The system may, for example, include one or more client devices, one or more application servers, one or more database server and include one or more Software as a Service providers. These devices may be interconnected and can communicate with each other via communication channels, such as Internet, satellite, telephone network, local area network (LAN), wireless network or the like. The client devices may include but are not limited to one or more of: personal computers, terminals, laptops, tablets, smartphone, and the like. The application servers and the database servers may be separate computing devices or combined in a single computing device.

The application servers can provide or allow access between one or more functions or services and a plurality of client devices. The application servers may be a computing device having a large storage capacity, at least one microprocessor, and at least one network or internet connection. Examples of the function or service provided by the application server include, without limitation, a web or mobile application. The components of the application server can support the construction of dynamic web pages or mobile app data. The database server can provide database service to the application server or the client devices connected in the network, or both. The database server may provide function of data analysis and data storage.

In some embodiments of the system of the present invention, the application server includes a data processing unit, an audio-visual alteration unit, a facial recognition unit, a personality assessment unit and a physical location unit. The data processing unit is provided to process data (receive, analyze, select for masking, etc.) related to candidates and employers and mask off (hide, cover) certain attributes of the data. The audio-visual alteration unit alters certain attributes during the audio or audio-video call (interview) to protect identity of the candidate. The facial recognition unit is provided to verify identification of the candidate at the time of interview and to share the emotions of altered or masked video resumes/calls. The personality assessment unit is to assess and/or predict the personality (e.g., personality traits) of the candidate based on data (e.g. words used by the candidate in the resume or during an interview or other communication to help employers know and understand the personality of the job seeker (candidate) and the rapport between the two. A voice or audio recognition (authentication) unit may be provided an alternative or additional technique to verify identification of the candidate at the time of and throughout the interview and to share the emotions of masked video resumes/calls. The physical location unit provides multiple physical locations, connected over a distributed network, to offer an exclusive place for recording video/audio resumes and participate in interview.

Additionally, identification of the candidate may be verified again at any one or more additional points during the interview, to ensure that no substitutions are made with other persons. This identification re-verifying of the candidate may be performed according to any identification attributes of the candidate using any one or more of analysis techniques including, without limitation, facial analysis, voice analysis, finger print comparison, retina scanning, etc.

The data processing unit includes, but not limited to, a data collection component, a database provided by the data server, a data parsing (analysis) component, and a data masking/filter component. The data collection component is provided to collect data. The data includes all necessary information from candidates and employers, and also, a request from an employer to find suitable candidate(s). The information may include talent oriented attributes, such as work experience, education level and subject, skills, training, certifications, awards, publications, expectations, professional achievements, and the like, as well as personal attributes, such as color, gender, age, disability, religion, ethnicity, sexual orientation, appearance, clothes, pregnancy, parental status, marital status, caste, class, address, phone number, accent, salary, college, location, residential address, employment timeline, and the like. In one example, a candidate uploads his/her resume, may it be in written format (e.g., text in MS Word or other word processing application format, or printed hardcopy format), audio format, or video format. According to one aspect of the invention, the data collection component may verify whether some or all of the required attributes for a particular job opening or prospective employer have been furnished in the uploaded resume. If yes, then, the resume is stored in the database. In another example, a candidate creates his/her resume using the system which could be word, video or audio based or a combination or word and video, or audio and word. The system may provide a format or list of questionnaire to the candidate. The candidate may fill up all the details and submit it. The data collection component may store the details into the database.

When a request from a recruiter or prospective employer about a job opening is received, the data collection component collects further information defining candidate expectations and requirements from the employer. The information may include, but may not be limited to, minimum qualification requirement, minimum work experience, job field, education level and subject, training, required skills, desirable skills, personality, and the like (e.g., collectively, required talent attributes).

The data parsing (analysis) component parses (analyzes) data stored in the database to find resumes suitable for the job requirement. In one embodiment, a matching algorithm is employed by the data analysis component to find an exact match between the job requirements and candidates' attributes. All exact matching resumes are short listed to be shared with the employer. In another embodiment, a proximity matching algorithm is employed. In such embodiment, required minimum standard is acquired by the employer, say list of minimum attributes expected to be exactly matched, priority of attributes, and the like. For example, minimum qualification must be Bachelors of Engineering and required attribute of highest priority must be F5 load balancing skills. The resumes with minimum qualification of Bachelors in Engineering and F5 load balancing skills will be short listed on priority. In one scenario, if the employer has asked for maximum 10 resumes, the data analysis component can analyze the database to find maximum 10 resumes best fitted in closest proximity to the requirements set by the employer.

Shortlisted resumes are then preceded towards the masking/filter component. The masking/filter component identifies the required talent attributes and personal attributes of the candidate. For example, candidate's work experience, qualification, skills and the like are identified as talent oriented attributes; wherein his/her color, gender, age, disability, religion, ethnicity, sex orientation, appearance, clothes, pregnancy, parental status, marital status, caste, class, address, phone number, accent, salary, college, location, residential address, employment timeline, and the like are identified as personal attributes. The masking/filter component masks/filters the personal attributes from the resume/system and shares it with the employer. May it be audio resume or video resume, part of the resume disclosing personal attributes is tampered/altered. As the employer will only be able to view talent oriented attributes, and not the personal attributes, the employer will have to process the resumes based on only capability and talent of the candidate. Thus, possibility of impermissible discrimination can be avoided in this phase. If resume is found suitable, the candidate is called in for an interview.

A facial analyzer component is provided to verify identify of the candidate using biometric technology before the interview process. Before starting the interview process, the candidate may have to log in into the system. His/her identification attributes are captured, such as finger print, facial characteristics, retina scan, and the like. The captured identification attributes are then compared, by a verification component, with the same identification attributes already stored in the database for that candidate. If both the stored and captured attributes match, the candidate can successfully log in into the system and proceed with the scheduled interview. This unit may also capture the candidate's emotional and behavioral responses during the video interview process.

The audio-visual unit is provided to conduct audio or video interview calls with altered identity of the candidate. The audio-visual unit includes one or more capture or display devices, such as a web-camera, a digital camera, a biometric scanner, a finger print scanner, a retina scanner, a microphone, a virtual or hardware keyboard, printer, and the like. It should be noted that conventional smart phones typically include one or more of a digital camera, a biometric scanner, a finger print scanner, a retina scanner, a microphone, and a virtual keyboard.

In one embodiment, the interview can be a video interview which is scheduled through a video call. Appearance of the candidate which is revealed during a video call can easily disclose his/her personal attributes, such as race, gender, age, ethnicity, and the like. A video alteration component (which may be part of the audio-visual unit or a separate device) is capable of scanning each image frame from the video, identifies the candidate by comparing personal attributes from scanned images to personal attributes already stored in a database. The video alteration component is also capable of masking or otherwise altering the scanned image to be viewed by the employer or other interviewer by replacing the scanned image with another image, or simply blurring the scanned image before providing it to the employer or other interviewer. At the same time, an audio alteration component (which may be part of the audio-visual unit or a separate device), such as voice filters, may be employed to alter the candidate's voice. The audio alteration component may be used to alter the candidate's voice during an audio interview as well. One or both of the video and audio alteration components may be present and, separately, one or the other, or both, may be applied during any video interview. Furthermore, video and audio alteration components may be applied, independently or together, sequentially or concurrently, to a video interview live, interactive, recorded, or combination thereof. Similarly, in some embodiments, the interview may be an audio interview, whether live, interactive, recorded, or a combination thereof, and, in such cases, the audio alteration component may be applied to alter the candidate's (or other user's voice), during or after the interview.

Apart from video and audio alteration, the audio-visual processing unit is capable of capturing, using one or more capturing devices, at least one of speech signal, facial expressions, and body language of the candidate throughout the interview. The facial analyzer component is used for conducting further analysis. In example of a video call analysis, video signal is received and one or more facial parameters are extracted from it. Examples of facial parameters include, but are not limited to, lip-reading and facial expressions. Each parameter is assigned with a value defining a particular emotional state. By calculating maximum values at adequate frequency, using a face analysis algorithm, emotional state of the candidate is analyzed. It is to be understood that the emotional state analysis can be performed using other various methods and is not limited to the face analysis algorithm.

Likewise, lip-reading, facial coloring, speech analysis, and words used during texts or conversations are few examples of the attributes that can be considered to analyze emotional state as well as personality type of the candidate. Once the attributes are captured, different algorithms, such as stress analysis algorithm, personality analysis algorithm, mood deviation analysis algorithm, and the like, can be employed to analyze emotional and behavioral strength and weaknesses of the candidate.

To this end, by protecting, masking, or camouflaging the identity of the candidate, prevention of discrimination during the recruitment can be assured. However, another concern linked with the unfair recruitment also needs to be addressed. When an interview is arranged through any communication medium, there is possibility of a candidate employing impermissible help, for example, from a friend present in the same room or accessing an electronic device, such as laptop or smartphone for searching an answer. Using such external help to answer questions during an interview is deceptive and obviously unfair to an interviewer and other candidates. The present invention provides the physical location unit to prevent the candidate from seeking such external assistance. The physical location unit is a distributed network of rooms, cabins, chambers, or any such place from where the candidate can access the client's device. Such locations may be established in major cities across any country and may include at least one client device connected to the application server. The candidate will be required to enter the room without his/her personal electronic belongings, such as smartphone or laptop. The candidate can access the client's device installed inside the room. Upon presenting his/her registered credentials, he will be logged in into the system and can appear for the interview. Because of such provision of the location, the candidate will be abstained from seeking any external assistance; thus more secured, sincere, and confidential interview process will be provided.

It is to be noted that the physical location unit is not limited to the interview process. It can also be used to facilitate a candidate or employer if he wishes to access the client's device for registration process, recording video/audio resumes, submitting a request from job opening, check the status of current job openings, and the like. Any candidate or employer can access the system from the physical locations.

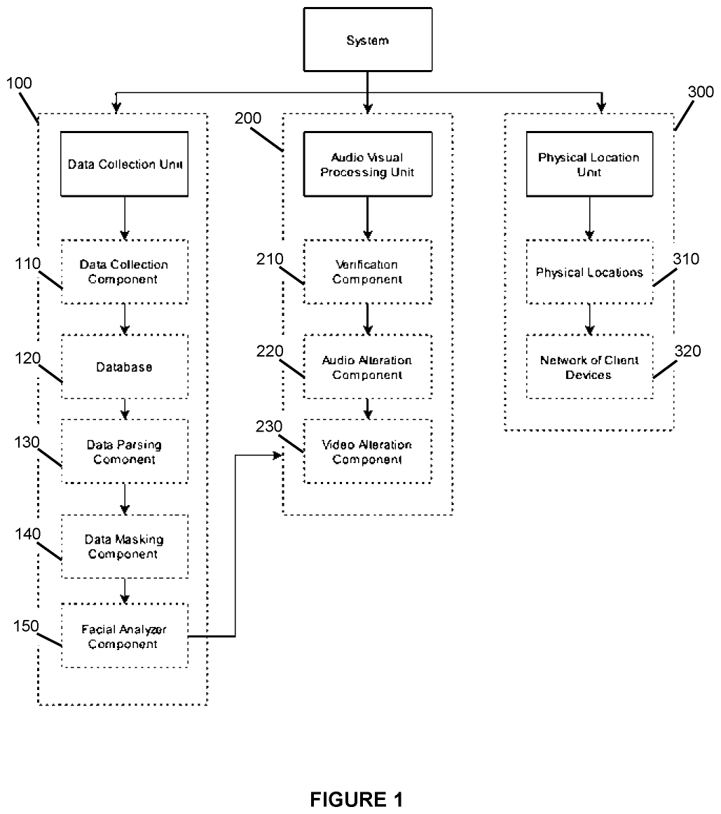

In an exemplary embodiment, shown schematically in FIG. 1, a system in accordance with the invention described herein comprises a data collection unit 100, an audio visual processing unit 200, and a physical location unit 300. In such an embodiment, these units 100, 200, 300 and their sub-units function as described above in connection with the various operations and capabilities explained above. The data collection unit 100 comprises at least a data collection component 110 for collecting and acquiring various data including, but not limited to, the personal attributes, talent attributes and identification attributes of one or more users of the system, as well as at least one database 120, such a candidate database, a job database, etc., and a data parsing (analysis) component 130 for analyzing, assessing and processing data in a communication. Furthermore, the data collection unit 100 further comprises a data modifying component 140 for masking, altering, or both, one or more personal attributes of a user prior to sharing a communication (such as a resume, interview or job description) with another user. In some embodiments, the data collection unit 100 also comprises a facial analyzer component 150 for acquiring and analyzing facial features of a user, for example, to determine user identity or emotion expressed by the user.

As also shown in FIG. 1, an exemplary embodiment of the system, the audio visual processing unit 200 may optionally comprise a verification component 210 to verify user identity, for example, by analyzing whether identification attributes of a user (e.g., acquired by the data collection component 110) correspond to previously recorded identification attributes of a candidate (e.g., stored in a candidate database 120). Furthermore, the audio visual processing unit 200 may, optionally, further comprises an audio alteration component 220 for masking or altering (or both), one or more personal attributes contained in audio data provided by a user (e.g., acquired by the data collection unit 110) and producing a modified audio file containing the masked or altered (or both) personal attributes. Similarly, the audio visual processing unit 200 may also, optionally, comprise a video alteration component 230 for masking or altering (or both) one or more personal attributes contained in video images provided by a user (e.g., acquired by the data collection unit 110) and producing a modified video file containing the masked or altered (or both) personal attributes. As described above in connection with the method for unbiased recruitment, such modified audio and video files are correlated and combined to produce a modified communication which includes the masked, altered, or masked and altered, personal attributes, whereby, during subsequent receiving and reviewing of the modified communication by a second user, the second user is unable to view or recognize the masked, altered, or masked and altered, personal attributes of the candidate which would otherwise have been recognizable in the communication prior to the masking, altering, or both, of the personal attributes.

With reference still to FIG. 1, in an exemplary embodiment of the system, the physical location unit 300 may optionally comprise one or more physical locations 310 for use and purposes described above in connection with the method for unbiased recruitment. Furthermore, the physical location unit 300 may optionally comprise a network of client devices 320, such as for example, one or more computer terminals, laptops, tablets, etc. for use by users for access the system and perform the method for unbiased recruitment as described in detail above.

In some embodiments, the system for unbiased recruiting may further include a search module which enables users such as candidate job seekers, recruiter, employers, etc. to search nearby matched candidates or recruiters/employers with a smartphone camera coupled with an augmented reality processor or application. Such searching of nearby matched users is anonymous, while the searching party sends an invitation to a matched party to connect and communicate directly. Only after the matched party “accepts” the invitation, are the identities of one or both of the searching party and the matched party disclosed to the other to continue the investigation and possible interview process.

Embodiments and features of the present invention are described herein; however, it is to be understood that the disclosed embodiments are merely exemplary of the invention, which may be embodied in various and alternative forms. While exemplary embodiments are described herein, it is not intended that these embodiments limit the scope of the invention. Rather, the terminology and words used in the specification are words of description rather than limitation, and it is understood that various changes may be made without departing from the scope of the invention. Additionally, the features of various implementing embodiments may be combined to form further embodiments of the invention.

1. A method for unbiased recruitment which includes a communication involving one or more users, wherein the communication may be live, interactive, recorded, or a combination thereof, and the user has one or more personal attributes, the method comprising the steps of:
receiving the communication from a first user, wherein the communication comprises: a text file containing words which include at least one personal attribute, an audio file containing audio data which include at least one personal attribute, a video file containing video images which include one or more personal attributes of the first user, or a combination thereof;
masking, altering, or both, one or more of the personal attributes in the communication, prior to providing the communication with another user, by subjecting whichever one or more of the text file, audio file, and video file that are present in the communication to a processing technique to produce a modified text file, a modified audio file, and a modified video file, respectively, which contain masked, altered, or masked and altered, personal attributes;
correlating and combining one or more of the modified text file, the modified audio file, and the modified video file to produce a modified communication which includes the masked, altered, or masked and altered, personal attributes;
whereby, during subsequent receiving and reviewing of the modified communication by a second user, the second user is unable to view or recognize the masked, altered, or masked and altered, personal attributes of the candidate which would otherwise have been recognizable in the communication prior to the masking, altering, or both, of the personal attributes.

2. The method of claim 1, further comprising the step of providing the modified communication to the second user.

3. The method of claim 2, wherein the step of providing the modified communication to the second user comprises: allowing receiving and reviewing of the modified communication by the second user continuously during at least a portion of the step of correlating and combining to produce the modified communication, storing the modified communication on storage media for future receiving and reviewing by the second user, or both.

4. The method of claim 1, wherein the personal attributes comprise one or more attributes selected from: color, gender, age, disability, religion, ethnicity, sexual orientation, appearance, clothes, pregnancy, parental status, marital status, caste, class, address, phone number, accent, salary, college, location, residential address, and employment timeline.

5. The method of claim 1, wherein altering comprises one or more of: replacing one or more personal attributes with: an alpha-numeric symbol, a graphic symbol, an emoticon, an emoji, an avatar, a color, a geometric shape.

6. The method of claim 1, wherein the communication is recorded, live, interactive, or a combination thereof, and selected from: a resume, an interview, a job description, an employer description, or a combination thereof.

7. The method of claim 6, wherein, when the communication is live, the step of masking, altering, or both, one or more of the personal attributes in the communication and the step of correlating and combining to produce the modified communication which includes the masked, altered, or masked and altered, personal attributes are both performed concurrently and continuously during at least a portion of the step of receiving the communication from the first user.

8. The method of claim 6, wherein the first user is a candidate, the communication is a recorded, live or interactive resume, or a recorded, live or interactive interview, and the second user is an employer or an agent thereof, an interviewer, or a recruiter.

9. The method of claim 8, wherein the resume is either:
a written resume comprising a text file,
an audio resume comprising an audio file and, optionally, also a text file, or
an audio-video resume comprising an audio file and a video file and, optionally, also a text file.

10. The method of claim 8, wherein the interview is either:
a written interview comprising a text file,
an audio interview comprising an audio file and, optionally, also a text file, or
an audio-video interview comprising an audio file and a video file and, optionally, also a text file.

11. The method of claim 10, wherein the interview is an audio-video interview which is live, recorded, interactive, or a combination thereof, and comprises an audio file and a video file, and, optionally, also a text file.

12. The method of claim 6, wherein the first user is an employer or agent thereof, or a recruiter, and the communication comprises: an interview, a job description, an employer description, or a combination thereof.

13. The method of claim 12, wherein the job description is either:
a written job description comprising a text file,
an audio job description comprising an audio file and, optionally, also a text file, or
an audio-video job description comprising an audio file and a video file and optionally, also a text file.

14. The method of claim 1, wherein the user is a candidate having one or more identification attributes unique to the candidate, and a candidate database which is accessible by the manager module contains one or more previously stored identification attributes of the candidate, the method further comprising the step of verifying candidate identity prior to commencing the communication by:
acquiring at least one identification attribute from a user wishing to participate in performing the communication;
retrieving the one or more previously stored identification attributes from the candidate database;
determining whether any of the acquired identification attributes of the user matches any of the one or more previously stored identification attributes from the database; and
if the result of the determining step is a match, reporting verification of the candidate identity and allowing the user to participate in the communication as the candidate, or
if the result of the determining step is failure to match any previously stored identification attributes, then reporting failure of verification of the candidate identity to the candidate and any other user intending to communicate with the candidate.

15. The method of claim 1, further comprising the step of analyzing the communication to determine one or more emotions expressed by the first user during the communication by:
subjecting one or both of an audio file and a video file of the communication to an emotional analysis technique to produce a first emotion data file comprising one or more emotional indicators each of which identify an emotion expressed by the first user during the communication; and
either:
correlating and integrating the first emotion data file with one or more of the text file, audio file, and video file, to produce the modified text file, the modified audio file, and/or the modified video file, respectively, such that the step of correlating and combining one or more of the modified text file, the modified audio file, and the modified video file produces a modified communication which further comprises the one or more emotional indicators; or
compiling and producing a report from the first emotion data file which is separate from the modified communication and contains the one or more emotional indicators, with or without time readings to indicate at which part of the communication the first user expressed or manifested the emotion,
wherein, optionally, a second user participates in the communication and the method for unbiased communication further comprises analyzing the communication to determine one or more emotions expressed by the second user during the communication by:
subjecting one or both of the audio file and the video file of the communication to an emotional analysis technique to produce a second emotion data file, which may be combined with the first emotion data file to produce a combined emotion data file which further comprises one or more emotional indicators each of which identifies an emotion expressed by the second user during the communication, or is a separate second emotion data file which comprises one or more emotional indicators each of which identifies an emotion expressed by the second user during the communication; and either
correlating and integrating the second emotion data file or the combined emotion data file with one or more of the text file, audio file, and video file, to produce the modified text file, the modified audio file, and/or the modified video file, respectively, such that the step of correlating and combining one or more of the modified text file, the modified audio file, and the modified video file produces a modified communication which further comprises the one or more emotional indicators; or
compiling and producing a report from the second emotion data file which is separate from the modified communication and contains the one or more emotional indicators each of which identifies an emotion expressed by the second user during the communication, with or without time readings to indicate at which part of the communication the second user expressed or manifested the emotion.

16. The method of claim 1, further comprising the steps of:
subjecting the text file, the audio file, or both to a personality analysis technique to determine one or more personality traits possessed by the first user; and
producing a personality report containing the one or more personality traits, a personality description, a personality profile, or a combination thereof.

17. A system for performing unbiased recruitment of a candidate for job openings, the system comprising:
an application server comprising at least an audio-visual processing unit and a data processing unit;
a job database server in communication with the application server and having stored thereon one or more job openings and one or more required talent attributes associated with each job opening;
a candidate database server in communication with the application server and having stored thereon one or more identification attributes associated with the candidate, one or more personal attributes associated with the candidate, and one or more talent attributes associated with the candidate, wherein the attributes are written words, audio signals, video images, or a combination thereof;
at least one user interface unit in communication with the application server and comprising one or more capture or display devices and being capable of enabling users selected from the candidate, an interviewer, and a recruitment manager, to communicate with the application server and each other to perform the unbiased recruitment; and
optionally, a physical location unit comprising one or more restricted access physical locations, each of which includes a user interface device, and wherein the candidate is prohibited from bringing any personal electronic devices into any of the physical locations.

18. The system of claim 17, wherein the audio-visual processing unit comprises one or more of:
a verification component capable of verifying identification of the candidate by accessing the candidate database and comparing one or more identification attributes of the candidate stored therein with one or more identification attributes acquired by the one or more capture or display devices of the user interface unit;
an audio alteration unit capable of receiving one or more audio signals from the candidate through one or more capture devices of the user interface unit, altering the received audio signals, and providing the altered audio signals to the interviewer through the one or more display devices of the user interface unit;
a video alteration unit capable of receiving one or more video images from the candidate through one or more capture devices of the user interface unit, altering received video images, and providing the altered video images to the interviewer through the one or more display devices; and
a search module comprising a smartphone camera coupled with an augmented reality processor or application and which is capable of searching nearby matched candidates with one or more of a matched recruiters, matched employer or agent thereof, matched interviewer, or a combination thereof.

19. The system of claim 17, wherein the application server further comprises a facial recognition unit capable of receiving facial feature data from the one or more capture devices of the user interface unit, analyzing the facial feature data, verifying identification of the candidate prior to an interview, and determining emotions of the candidate during an interview which may be otherwise undetectable by the interviewer due to altering or masking of the video images.

20. The system of claim 17, wherein the altered audio signals and the altered video images are sufficiently altered such that the interviewer is unable to recognize personal attributes of the candidate would otherwise have been recognizable based on the audio signals or the video images, respectively, prior to altering.
